(19) United States
(12) Patent Application Publication
(10) Pub. No.: US 2025/0084635 A1
(43) Pub. Date: Mar. 13, 2025

(54) PRODUCT COMPRISING A MINERAL WOOL TO BE BLOWN

(71) Applicant: SAINT-GOBAIN ISOVER, COURBEVOIE (FR)

(72) Inventors: Amaury RONY, PARIS (FR); Alexia MICHEL, PARIS (FR); Elodie PERROS, CLAMART (FR); Delphine TOULEMON, VINEUIL-SAINT-FIRMIN (FR)

(21) Appl. No.: 18/290,669

(22) PCT Filed: Jul. 21, 2022
(86) PCT No.: PCT/FR2022/051460

§ 371 Date: Jan. 19, 2024

(30) Foreign Application Priority Data
Jul. 21, 2021 (FR) FR2107879
Feb. 4, 2022 (FR) FR2201006
Feb. 4, 2022 (FR) FR2201008

(51) Int. Cl. E04B 1/88; C03C 25/14

(52) U.S. Cl. CPC E04B 1/88; C03C 25/14

(57) ABSTRACT

A thermal insulation product includes a mineral wool, the mineral wool including mineral fibers, the fibers having a fiber length population distribution such that the median fiber length by number of the distribution is less than or equal to 2 mm, and that at least 10% of the number population has a fiber length strictly greater than 1.5 mm and, the product including at least one additive, the product having a weight percent of the total of the at least one additive of between 0.4% and 1.2% inclusive.

### FIELD OF THE INVENTION

The present invention relates to a thermal and/or acoustic insulation product comprising a mineral wool to be blown, preferentially a glass wool, as well as a coating obtained by the blowing of such a product.

### STATE OF THE ART

It is known to thermally and/or acoustically insulate a barrier of a building, for example a wall, a floor or a ground, by depositing a blown glass wool in contact with the barrier. A compressed glass wool in a bag undergoes a first expansion during the opening of the bag. The glass wool is then introduced into a device configured to blow the glass wool, comprising for example a carder, wherein the glass wool is subjected to a second expansion. The glass wool is then transported from the machine to the barrier to be insulated in a pneumatic conduit. This method makes it possible to cover a barrier having an irregular morphology with glass wool. This method also makes it possible to reduce the volume of the glass wool between its production and its use.

However, during the deposition of the glass wool on the barrier, a significant part of the glass wool can be dispersed in the ambient atmosphere. The dispersed part in the atmosphere is qualified as glass wool “dust”. This dust has a problem of user comfort during the blowing of the glass wool.

It is known to reduce the amount of dust emitted during the blowing of the glass wool and thus to increase the comfort of the user by adding a mineral oil to the glass wool.

However, the addition of mineral oil into the glass wool causes an increase in the thermal conductivity A of the blown glass wool, which reduces the thermal and/or acoustic performance of the blown glass wool.

To this end, document US 2017 0198472 describes a glass wool wherein the mineral oil weight percent has been reduced compared to the prior art. The mineral oil weight percent of the mineral wool described in document US 2017 0198472 is between 0.1% and 0.6% of the total mass of the mineral wool.

However, the glass wool described by document US 2017 0198472 has a high thermal conductivity for a predetermined density of glass wool installed on a barrier. Furthermore, the glass wool described leads to a large amount of dust dispersed in the ambient atmosphere during its blowing. Thus, there is a need to produce a glass wool having both a low thermal conductivity for a predetermined installed glass wool density and a high installation comfort for the user.

### OVERVIEW OF THE INVENTION

One aim of the invention is to propose a thermal and/or acoustic insulation product having a thermal conductivity less than or equal to the thermal conductivities of known mineral wools, while minimizing the amount of dust emitted during the installation of the product by a user.

This aim is achieved within the scope of the present invention by virtue of a thermal and/or acoustic insulation product comprising a mineral wool, the mineral wool comprising mineral fibers and being suitable for being blown, wherein:
the fibers have a fiber length population distribution such that the median fiber length by number of the distribution is less than or equal to 2 mm, and that at least 10% of the population in number has a fiber length strictly greater than 1.5 mm, in particular strictly greater than 2.0 mm, and preferentially strictly greater than 2.5 mm,
the product comprises at least one additive, the product having a weight percent of the total of the additive(s) between 0.4% and 1.2% inclusive, in particular between 0.6% and 1% inclusive and preferentially between 0.7 and 0.9% inclusive.

The present invention is advantageously completed by the following features, taken individually or in any of their technically possible combinations:
the median fiber length by number of the distribution is less than or equal to 1.5 mm and preferably 1 mm,
the mineral wool is a glass wool,
the product has a density between 100 kg·m⁻³ and 180 kg·m⁻³ inclusive, in particular between 120 kg·m⁻³ and 160 kg·m⁻³ inclusive and preferentially between 140 kg·m⁻³ and 160 kg·m⁻³ inclusive,
the additive(s) comprise at least one additive selected from an anti-dust additive, a hydrophobing additive, an antistatic additive and a dye,
the additive(s) comprise an antistatic additive, a weight percent of the antistatic additive being between 0.01% and 0.30% inclusive, in particular between 0.02% and 0.20% inclusive, and preferentially between 0.05% and 0.15% inclusive,
the additive(s) comprise an antistatic additive, the antistatic additive being selected from a tertiary ammonium, a quaternary ammonium and a polyethylene glycol,
the additive(s) comprise a hydrophobing additive, a weight percent of the hydrophobing additive is between 0.05% and 0.4% inclusive,
an average length of the fibers by number of fibers is between 0.5 mm and 1.5 mm inclusive,
a volume-weighted median diameter of the fibers is between 5 μm and 15 μm inclusive, in particular between 6 μm and 12 μm inclusive, and preferentially between 7 μm and 10 μm inclusive,
the median fiber length in number is between 300 μm and 700 μm,
the product is able to have, after having been blown, a thermal performance factor χ between 0.45 W·kg⁻¹·m⁻⁴ and 0.8 W·kg·K⁻¹·m⁻⁴, and in particular between 0.5 W·kg·K⁻¹·m⁻⁴ and 0.75 W·kg·K⁻¹·m⁻⁴,
the mineral wool has a micronaire of between 4 L/min and 9 L/min,
Another aspect of the invention is a thermal and/or acoustic insulation coating obtained by blowing a product according to one embodiment of the invention, the coating having a thermal performance factor χ between 0.45 W·kg⁻¹·m⁻⁴ and 0.8 W·kg·K⁻¹·m⁻⁴, and in particular between 0.5 W·kg·K⁻¹·m⁻⁴ and 0.75 W·kg·K⁻¹·m⁻⁴.

Advantageously, the coating has a blown density between 5 kg/m³ and 18 kg/m³ inclusive, in particular between 7 kg/m³ and 12 kg/m³ inclusive.

Advantageously, the coating has a thermal conductivity of between 35 mW·m⁻¹·K⁻¹ and 55 mW·m⁻¹·K⁻¹ inclusive, in particular between 40 mW·m⁻¹·K⁻¹ and 52 mW·m⁻¹·K⁻¹ inclusive, and preferentially between 43 mW·m⁻¹·K⁻¹ and 49 mW·m⁻¹·K⁻¹ inclusive.

Another aspect of the invention is a use of a product according to an embodiment of the invention for thermal and/or acoustic insulation of a barrier of a building.

### DESCRIPTION OF THE FIGURES

Other features, purposes and advantages of the invention will emerge from the following description, which is purely illustrative and non-limiting, and which must be read in conjunction with the appended drawings in which:

FIG. 1 shows a fiber length population distribution of a product according to one embodiment of the invention.

FIG. 2 schematically shows a facility for producing an insulation product according to one embodiment of the invention,

FIG. 3 shows the integrated average charge of the mineral fibers of a product according to one embodiment of the invention, blown.

FIG. 4 shows the variation in the consumption of a coating with the weight percent of all additives and fiber length distribution.

In all the figures, similar elements are marked with identical references.

### Definitions

“Thermal performance factor χ” means the product of the thermal conductivity λ, expressed in W·m⁻¹·K⁻¹, and density ρ of a product according to one embodiment of the invention when blown, expressed in kg/m³. The thermal performance factor χ is, in a known manner, representative of the quantity of mineral wool to be blown in order to obtain a predetermined thermal resistance R on a barrier. Thus, the thermal performance of the mineral wool can be determined by the product of the predetermined thermal resistance R and the thermal performance factor χ.

“Blowing” a mineral wool means blowing as defined by standard EN 14064-1:2007, and preferentially as defined by the document “Cahier Technique 8, Confection des éprouvettes d'essais pour les produits en vrac, Indice de révision C, date de mise en application: Jan. 7, 2019, ACERMI”, referring to Annex C.2.1 of standard EN 14064-1:2007.

Thermal conductivity is measured according to the measurement defined in the document “Cahier Technique 8, Confection des éprouvettes d'essais pour les produits en vrac, Indice de révision C, date de mise en application: Jan. 7, 2019, ACERMI”, referring to standard EN 14064-1:2007.

“Density” of a mineral wool means the mass of mineral wool measured in a container totally filled with mineral wool, divided by the volume of the container. In the case of a mineral wool packaged in a bag for transporting the mineral wool, the density of the mineral wool is equal to the ratio between the mass of the mineral wool in the bag and the volume of the bag. In the case of a blown mineral wool, the measurement of the density of the blown mineral wool is defined in the document “Cahier Technique 8, Confection des éprouvettes d'essais pour les produits en vrac, Indice de revision C, date de mise en application: Jan. 7, 2019, ACERMI”, referring to Annex C.2.1 of standard EN 14064-1:2007.

In the present application, the fineness of the mineral wool fibers is determined by the value of their micronaire, under 5 g. The micronaire measurement, also called the “fineness index”, is representative of the specific surface area of the fibers, and comprises measuring the aerodynamic pressure drop when a given amount of fibers extracted from an unsized mat is subjected to a given pressure of a gas, in general air or nitrogen. This measurement is standard practice in mineral fiber production units; it is standardized (DIN 53941 or ASTM D 1448 standards) and uses what is called a “micronaire tester”. The method for measuring the micronaire is also described in document WO 2003098209.

### DETAILED DESCRIPTION OF THE INVENTION

### General Structure of the Thermal/Acoustic Insulation Product

One aspect of the invention is a thermal and/or acoustic insulation product comprising a mineral wool. Preferably, the mineral wool is a glass wool. The mineral wool comprises mineral fibers. The glass wool comprises, in a known manner, glass fibers. The mineral fibers are produced by the melting of an inorganic raw material, preferably glass, stone, and/or slag. The mineral wool is suitable for being blown.

Preferably, the mineral fibers can be produced by melting a glass having:
a weight percent of SiO₂ between 50% and 75%, and preferably between 60% and 70%, and/or
a weight percent of Na₂O between 10% and 25%, and preferably between 10% and 20%, and/or
a weight percent of CaO between 5% and 15%, and preferably between 5% and 10%, and/or
a weight percent of MgO between 1% and 10%, and preferably between 2% and 5%, and/or
a sum of a weight percent of CaO and of a weight percent of MgO of between 5% and 20%, and/or
a weight percent of B₂O₃ between 0% and 10%, in particular between 2% and 8%, preferably between 3% and 6%, and more preferably between 3.5% and 5%; and/or
a weight percent of Al₂O₃ between 0% and 8%, and preferably between 1% and 6%, and/or
a weight percent of K₂O between 0% and 5%, and preferably between 0.5% and 2%, and/or
a sum of a weight percent of Na₂O and of a weight percent of K₂O between 12% and 20%.

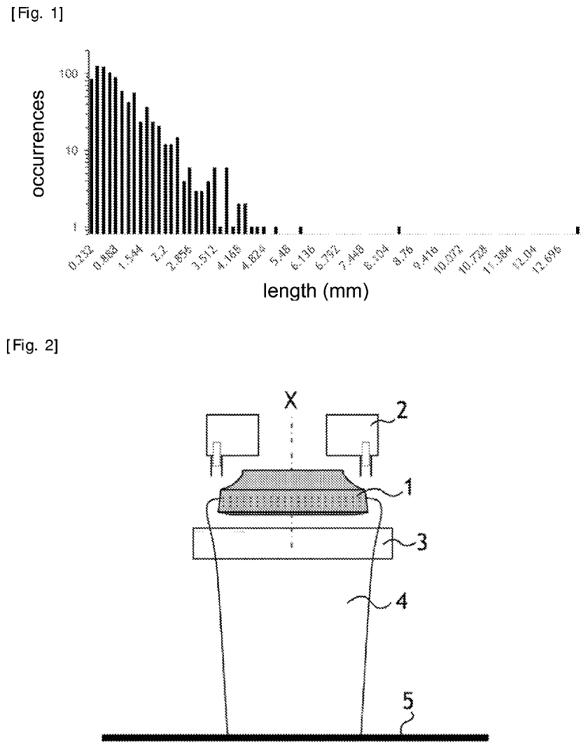

With reference to FIG. 1, the fibers have a fiber length population distribution such that the median fiber length by number of the distribution is less than or equal to 2 mm, in particular less than or equal to 1.5 mm, and preferentially less than 1 mm. Additionally, at least 10% of the population in number has a fiber length strictly greater than 1.5 mm, in particular strictly greater than 2.0 mm, and preferentially strictly greater than 2.5 mm.

The product comprises at least one additive. The product has a weight percent of the total of the additive(s) between 0.4% and 1.2% inclusive, in particular between 0.6% and 1% inclusive and preferentially between 0.7 and 0.9% inclusive.

The inventors have discovered that it was thus possible to minimize the thermal conductivity of the insulation product while limiting the emission of dust during the blowing of the insulation product, by combining the weight percent of additive described above with the fiber length distribution described above, having both a large proportion of short fibers and long fibers.

Preferably, the insulation product may have a binder weight percent of less than 0.1%. In particular, the insulation product may be devoid of binder, and have a binder weight percent of zero. However, traces of binder may be present, in particular when the product is manufactured by recycling a glass wool comprising a binder.

With reference to FIG. 4, the consumption of a thermal insulation coating can be reduced in a synergistic manner by choosing a product that has a weight percent of all additives included within the range defined above, and by choosing a fiber length population distribution as defined above. The consumption is expressed as a percentage of the consumption of the coating corresponding to point (a). Point (a) illustrates a coating with a weight percent of the total of the additives equal to 1.6% and in which strictly less than 10% of the population by number of fibers has a length greater than 1.5 mm. Point (b) illustrates a coating with a weight percent of the total of the additives equal to 0.8% and in which strictly less than 10% of the population by number of fibers has a length greater than 1.5 mm. Point (c) illustrates a coating with a total additive content by weight of 1.6%, in which the fibers have a fiber length population distribution such that the median fiber length by number of the distribution is less than or equal to 2 mm, and in which at least 10% of the population by number has a fiber length strictly greater than 1.5 mm. Point (d) illustrates a coating according to one embodiment of the invention, having a weight percent of the total of the additives equal to 0.8% and in which the fibers have a fiber length population distribution such that the median fiber length in number of the distribution is less than or equal to 2 mm and in which at least 10% of the population in number has a fiber length strictly greater than 1.5 mm.

### Manufacture of the Insulation Product

Referring to FIG. 2, a facility for producing the insulation product may comprise a fiberizing unit, wherein the mineral fibers are produced. The fiberizing unit may comprise a centrifugation device 1 configured to rotate along a vertical axis X. The centrifugation device 1 has a peripheral strip. The peripheral strip is pierced by a plurality of orifices, through which the molten raw material can flow from the inside of the centrifugal device, forming filaments of molten raw material.

The fiberizing unit may also comprise a burner 2. The burner 2 may have an annular shape and be arranged so as to impose at the outlet of the orifices a gas flow at a controlled temperature. The burner 2 makes it possible to stretch the filaments exiting the orifices, so as to form the mineral fibers. An annular inductor 3 can be arranged below the centrifugation device. The annular inductor 3 makes it possible to heat a lower part of the centrifugation device 1, in particular the spinner. A web 4 of mineral fibers is thus formed. A belt 5 for receiving the mineral fibers can be arranged under the centrifugation device 1.

The burner 2 is configured so that the temperature of the gas jet at the outlet of the burner 2 is between 1300° C. and 1500° C., preferably around 1400° C. The pressure variation of the burner 2, driving the gas jet, makes it possible to control the fineness of the fibers: a lower burner pressure 2 can lead to a larger fiber diameter.

The inventors have discovered that it is possible to significantly increase the proportion of long mineral fibers among all of the mineral fibers produced, in the proportions described above, by decreasing the amount of movement transmitted by the burner 2 to the filaments at the outlet of the orifices with respect to the known amount of movement. Thus, the pressure of the burner 2 can be imposed between 400 mm CE and 800 mm CE, in particular between 400 mm CE and 450 mm CE (it is recalled that 1 mm CE=9.81 Pa).

The rotational speed can be between 1600 revolutions per minute and 3000 revolutions per minute, in particular between 2400 revolutions per minute and 3000 revolutions per minute.

The tangential speed of the orifices, during the rotation of the centrifugation device 1, may be between 50 m/s and 80 m/s, and preferably between 57 m/s and 75 m/s. Thus, it is possible to increase the proportion of fibers having a length strictly greater than 1.5 mm and preferentially strictly greater than 2.0 mm in the population of fibers of the product. Indeed, the length of the fibers can be increased by increasing the amount of movement provided to the fibers from the outlet of the orifice. However, the amount of movement provided to the fibers by the burner can be concomitant with mechanical stresses experienced by the fibers driven by fluid turbulences, downstream of the burner. These stresses can lead to the rupture of the fibers. Thus, the tangential speed of the orifices makes it possible to provide a sufficient amount of movement to the fibers while reducing the mechanical stresses experienced by the fibers in a turbulent fluid environment.

The daily fiber output per spinner orifice is equal to the throughput of molten material passing through each orifice per day. The daily fiber output per spinner orifice can be between 0.30 kg/day and 0.8 kg/day, in particular between 0.4 kg/day and 0.7 kg/day.

Preferably, the fiber output per orifice may be less than 0.40 kg/day. Thus, it is possible to reduce the diameter of the fibers with respect to the produced fibers with a higher output, and thus to counterbalance the effect of reducing the amount of movements transmitted by the burner 2 to the filaments at the outlet of the orifices.

The spinner of the centrifugation device 2 may comprise at least 30,000 orifices, for example when the spinner diameter is equal to 600 mm. Preferably, the spinner of the centrifugation device 2 may comprise at least 36,000 orifices, for example when the diameter of the spinner is equal to 400 mm. Thus, for a constant total output, the output per orifice is sufficiently small to produce fine fibers, so as to counterbalance the effect of the reducing the transmission of the amount of movement of the burner 2 on the filaments at the outlet of the orifices.

The spinner of the centrifugation device 2 has a diameter comprised between 50 mm and 800 mm, and preferentially between 400 mm and 600 mm. The output of the centrifugation device 2 varies with the diameter of the spinner.

The orifices are formed and distributed over the drilling strip of the spinner. The height of the drilling strip, along the direction of the rotation axis X of the centrifugation device, is preferably less than 35 mm. The diameter of the orifices is between 0.5 and 1.1 mm.

The distance between the centers of the neighboring orifices may be between 0.8 mm and 2 mm. This distance may vary by less than 10%, and preferably less than 3%. The distance between the centers of the neighboring orifices can decrease in a direction oriented toward the lower part of the spinner.

The manufacturing method can then comprise a step of recovering the mineral fibers on the belt 5. Following the recovery step, the manufacturing method may comprise a step of grinding the fibers, then a step of compressing the fibers. The grinding step can also be implemented so as to obtain a product according to one embodiment of the invention.

### Mineral Wool Structure and Geometry

A volume-weighted median diameter of the fibers may be between 5 μm and 15 μm inclusive, in particular between 6 μm and 12 μm inclusive, and preferentially between 7 μm and 10 μm inclusive, Thus, the insulation product may have a thermal conduction that is smaller than the thermal conduction of known insulation products, while making it possible to form the length distribution described above. Indeed, a median diameter that is too small can promote a reduction in the proportion of long fibers in the length distribution, due to breaks in the longest fibers. The range of the median diameter of the fibers of a product according to one embodiment of the invention makes it possible to avoid excessive breakage of the fibers while retaining a low thermal conductivity of the product.

An average fiber length, by number of fibers, may be between 0.5 mm and 1.5 mm inclusive. The median fiber length, by number of fibers, is between 300 μm and 700 μm. The insulation product may have a micronaire of between 4 L/min and 9 L/min.

The diameter and length of the fibers can be measured by depositing the fibers on a substrate, then imaging the deposited fibers with a microscope. A sample of the product or of the coating can be taken using a tweezer. Typically, between 10 and 30 mg of the product or the coating may be removed. The number of fibers measured is greater than 1000, in particular greater than 2000 and preferably greater than 5000. The fibers of the sample can then be dispersed in a solvent. The solvent may comprise a mixture of distilled water and glycerin, for example in a 500:1 proportion, and/or comprise a surfactant. The sample is stirred using a laboratory stirrer between 30 minutes and 2 hours, which results in a dispersion of the fibers in the solvent. The dispersion of fibers is then diluted in distilled water at a ratio of 1:3 to 1:20. The dispersion of diluted fibers is then deposited on a substrate, for example on the bottom of a Petri dish. The fibers included in the dispersion are then imaged by a microscope provided with an objective whose magnification is for example equal to 20×, 40× or 90×, or by any other imaging system (camera, scanner) making it possible to observe the fibers at sufficient resolution to assess their length. Image processing is then implemented. In each of the images, the pixel clusters of less than a few pixels or whose eccentricity is less than 0.5, that is to say the particles of roughly circular shape, are ignored. A wireframe is then applied to each of the images, so as to obtain the median axis of the fibers. Finally, a score function is then used to evaluate the probability that two fiber segments belong to the same fiber. The score function is also used to reconstruct the fibers that were broken into fiber segments during the thresholding step.

### Additives

In all embodiments of the invention, the product has a weight percent of the total of the additive(s) between 0.4% and 1.2% inclusive, in particular between 0.6% and 1% inclusive and preferentially between 0.7 and 0.9% inclusive. Thus, as described above and in combination with the fiber length distribution described, it is possible to maximize the thermal insulation of the product while limiting the emission of dust during the installation of the product. Indeed, additives, which usually comprise organic compounds, promote heat transfer through the product and thus degrade the thermal insulation properties conferred by the blown product. In the present application, the weight percent of all of the additive(s) is understood to mean all the additives of the product. The weight percent of all additives, the additives having different natures, is calculated by summing the weight percent of each of the additives just once. This definition of the weight percent of all of the additive(s) does not exclude an additive from having multiple functions. A function may be chosen at least among an anti-dust function, a hydrophobing function, an antistatic function and a dye function. The weight percent of one or more additives having a determined function is calculated by summing the weight percent of each of the additives having this determined function. This definition does not preclude that the weight percent of a first additive, having both a first function and a second function, is summed both in the weight percent of one or more additives having a first function as well as in the weight percent of one or more additives having a second function.

The additive(s) may be of any type. The additive(s) are preferentially selected from an anti-dust additive, a hydrophobing additive, an antistatic additive and a dye.

The thermal insulation product may comprise an antistatic additive. A weight percent of the antistatic additive may be between 0.01% and 0.30% inclusive, in particular between 0.02% and 0.20% inclusive, and preferentially between 0.05% and 0.15% inclusive.

The antistatic additive may be at least chosen from a tertiary ammonium, a quaternary ammonium, and a polyethylene glycol. Preferably, the antistatic additive comprises a polyethylene glycol and at least one compound selected from a tertiary ammonium and a quaternary ammonium.

The total weight percent of the tertiary ammonium and the quaternary ammonium may be between 0.01% and 0.25%, in particular between 0.01% and 0.05%. The weight percent of polyethylene glycol can be between 0.03% and 0.20%, in particular between 0.05% and 0.10%.

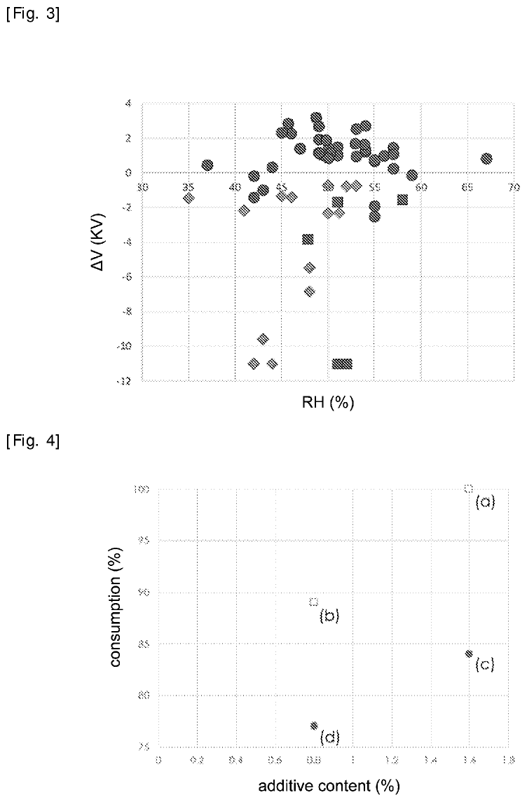

The antistatic additive can be sprayed onto the mat of mineral fibers 4 produced following the step of forming a web 4 of mineral fibers previously described and/or following the step of grinding the fibers, for example during the transport of fibers in a pneumatic channel. The antistatic additive makes it possible to increase the value of the electrostatic charge of the mineral fibers of the blown mineral wool. Thus, during the deposition of a coating obtained by the product blown onto the barrier to be insulated, the mineral fibers do not cling to the clothing of the user. With reference to FIG. 3, the measurement of the electrostatic charge of the blown mineral wool can be implemented by arranging, at the outlet of the conduit through which the blown product is brought to the barrier to be insulated, a mobile electrostatic sensor (for example a sensor of the Keyence SK-050 model). The sensor measures an electric potential difference A V near a path through which the blown product is transported, between an electrical potential measured as the blown product goes through the path, and an electrical potential measured at the same location, if the blown product does not go through the path. The measured potential difference is proportional to the average charge of the fibers going through the path, and changes in the same direction. The sensor may, for example, be arranged at the outlet of a pneumatic conduit used to deposit the blown mineral wool onto the barrier to be insulated.

The average charge of the blown mineral fibers of a product may be zero or positive. Indeed, it has been discovered by the inventors that a zero or positive average charge of the blown fibers was a sufficient condition to observe an antistatic effect of the product on the user's clothing. “Average charge” refers to the average of the charges of the mineral fibers measured during the blowing of the product. FIG. 3 shows the average charge of the fibers as a function of the relative humidity (HR) level.

The thermal insulation product may comprise an antistatic additive. An additive is said to be “hydrophobing” if, when deposited in the mineral wool, it enables the insulation product to have hydrophobic properties. The hydrophobing additive can be sprayed onto the web 4 of mineral fibers produced following the step of forming a web 4 of mineral fibers previously described. A weight percent of the hydrophobing additive may be between 0.05% and 0.4% inclusive, and preferably between 0.1% and 0.2%. The hydrophobing additive may be a silicone, for example polydimethylsiloxane (PDMS).

The thermal insulation product may comprise an antidust additive. The antidust additive can be sprayed onto the mat of mineral fibers 4 produced following the step of forming a web 4 of mineral fibers previously described and/or following the step of grinding the fibers, for example during the transport of fibers in a pneumatic channel. The antidust additive reduces the formation of dust during the blowing of the wool to be blown, and thus makes it possible to increase user comfort and to keep mineral fibers from penetrating into the airways of the user. The antidust additive may comprise an oil, in particular an oil of vegetable origin and/or an oil of mineral origin. Preferably, the weight percent of the dust additive can be determined so that the product has a weight percent of all of the additive(s) of between 0.4% and 1.2% inclusive, so that the weight percent of the antistatic additive is between 0.01% and 0.30%, and so the weight percent of the hydrophobing additive is between 0.05% and 0.4% inclusive. Preferably, the weight percent of the anti-dust additive is between 0.34% and 1.14%.

### Macroscopic, Thermal, and Consumption Properties of the Insulation Product

At the end of the method for manufacturing the product described above, in particular following the step of compressing the fibers, the product has a density greater than that of a coating obtained by blowing the product. The density may be between 100 kg·m⁻³ and 180 kg·m⁻³ inclusive, in particular between 120 kg·m⁻³ and 160 kg·m⁻³ inclusive and preferentially between 140 kg·m⁻³ and 160 kg·m⁻³ inclusive. This density may be the density of the packaged product. Thus, at equal volume, the product can be lighter when conditioned for other known products. As an example, known products obtained from rock wool have a density greater than 200 kg·m⁻³. It is thus possible to facilitate the conveyance of the product to a construction site.

Another aspect of the invention is a thermal and/or acoustic insulation coating obtained by blowing a product according to one embodiment of the invention.

The coating, and indirectly the product, can be used for the thermal and/or acoustic insulation of a barrier of a building. The barrier may be selected from a wall, a floor and a ground. The barrier may be insulated by depositing the coating by blowing the product.

Preferably, the coating has a thermal performance factor χ between 0.45 W·kg⁻¹·m⁻⁴ and 0.8 W·kg·K⁻¹·m⁻⁴, and in particular between 0.5 W·kg·K⁻¹·m⁻⁴ and 0.75 W·kg·K⁻¹·m⁻⁴, Thus, it is possible, in particular by the characteristics of the product before blowing, to limit both the consumption of the product to install a coating having a thermal resistance predetermined by the user, and the emission of dust emitted during the blowing of the product. The coating may have a thermal conductivity of between 35 mW·m⁻¹·K⁻¹ and 55 mW·m⁻¹·K⁻¹ inclusive, in particular between 40 mWm⁻¹·K⁻¹ and 52 mWm⁻¹·K⁻¹ inclusive, and preferentially between 43 mW·m⁻¹·K⁻¹ and 49 mW·m⁻¹·K⁻¹ inclusive. In addition, preferably in combination with the predefined thermal conductivities, the coating may have a blown density of between 5 kg/m³ and 18 kg/m³ inclusive, in particular between 7 kg/m³ and 12 kg/m³ inclusive.

1. A thermal and/or acoustic insulation product comprising a glass wool, the glass wool comprising mineral fibers and being suitable for being blown, wherein:
the fibers have a fiber length population distribution such that a median fiber length in distribution number is less than or equal to 2 mm, and that at least 10% of a population in number has a fiber length strictly greater than 1.5 mm,
the product comprises at least one additive, the product having a weight percent of the total of the at least one additive between 0.4% and 1.2% inclusive.

2. The thermal and/or acoustic insulation product according to claim 1, having a density of between 100 kg·m⁻³ and 180 kg·m⁻³ inclusive.

3. The thermal and/or acoustic insulation product according to claim 1, wherein the at least one additive comprises at least one additive chosen from an anti-dust additive, a hydrophobing additive, an antistatic additive and a dye.

4. The thermal and/or acoustic insulation product according to claim 3, wherein the at least one additive comprises an antistatic additive, a weight percent of the antistatic additive being between 0.01% and 0.30% inclusive.

5. The thermal and/or acoustic insulation product according to claim 3, wherein the at least one additive comprise an antistatic additive, and wherein the antistatic additive is selected from a tertiary ammonium, a quaternary ammonium and a polyethylene glycol.

6. The thermal and/or acoustic insulation product according to claim 3, wherein the at least one additive comprises a hydrophobing additive, a weight percent of the hydrophobing additive being between 0.05% and 0.4% inclusive.

7. The thermal and/or acoustic insulation product according to claim 1, wherein an average length of the fibers by number of fibers is between 0.5 mm and 1.5 mm inclusive.

8. The thermal and/or acoustic insulation product according to claim 1, wherein a volume-weighted median diameter of the fibers is between 5 μm and 15 μm inclusive.

9. The thermal and/or acoustic insulation product according to claim 1, wherein the median length of the fibers by number of fibers is between 300 μm and 700 μm.

10. The thermal and/or acoustic insulation product according to claim 1, able to have, after having been blown, a thermal performance factor χ between 0.45 W·kg·K⁻¹·m⁻⁴ and 0.8 W·kg·K⁻¹·m⁻⁴.

11. The thermal and/or acoustic insulation product according to claim 1, wherein the glass wool has a micronaire of between 4 L/min and 9 L/min.

12. A thermal and/or acoustic insulation coating obtained by blowing a product according to claim 1, the coating having a thermal performance factor χ between 0.45 W·kg·K⁻¹·m⁻⁴ and 0.8 W·kg·K⁻¹·m⁻⁴.

13. The thermal and/or acoustic insulation coating obtained by blowing a product according to claim 1, the coating having a blown density of between 5 kg/m³ and 18 kg/m³ inclusive.

14. The thermal and/or acoustic insulation coating obtained by blowing a product according to claim 1, the coating having a thermal conductivity of between 35 mW·m⁻¹·K⁻¹ and 55 mW·m⁻¹·K⁻¹ inclusive.

15. A method comprising providing a thermal and/or acoustic insulation product according to claim 1 for a thermal and/or acoustic insulation of a barrier of a building.
